(19) United States
(12) Patent Application Publication
(10) Pub. No.: US 2016/0203629 A1
(43) Pub. Date: Jul. 14, 2016

(54) INFORMATION DISPLAY APPARATUS, AND METHOD FOR DISPLAYING INFORMATION

(71) Applicant: Panasonic Intellectual Property Management Co., Ltd., Osaka (JP)

(72) Inventor: GENTARO TAKEDA, Osaka (JP)

(21) Appl. No.: 15/076,656

(22) Filed: Mar. 22, 2016

Related U.S. Application Data
(63) Continuation of application No. PCT/JP2015/001466, filed on Mar. 17, 2015.

(30) Foreign Application Priority Data
Mar. 28, 2014 (JP) 2014-068180
Jan. 20, 2015 (JP) 2015-008952

(51) Int. Cl. G06T 11/60; B60K 35/00; H04N 13/02; G06F 3/01; H04N 9/31

(52) U.S. Cl. CPC G06T 11/60; G06F 3/013; H04N 9/31; H04N 13/0239; B60K 35/00; B60K 2350/352

(57) ABSTRACT

An information display apparatus of the present disclosure includes: a display unit; a first detector which detects a current position and a direction of the information display apparatus; an acquisition unit which acquires area information; a generation unit which generates a first graphic object for providing guidance to a user about areas around the information display apparatus, and generates distance information indicating a first distance at which the first graphic object is to be displayed; a second detector which detects a second distance of an object in an area of the real environment corresponding to an area in which the first graphic object is displayed; a comparator which compares the first distance and the second distance; a display controller which displays on the display unit a second graphic object which is generated from the first graphic object by removing a first area of which the first distance is more distant from the information display apparatus than the second distance is.

### TECHNICAL FIELD

The present disclosure relates to an information display apparatus and a method for displaying information.

### BACKGROUND ART

Unexamined Japanese Patent Publication No. 2006-242859 discloses an information display apparatus for a vehicle which is capable of displaying information (graphic object) in such a manner that a driver safely and easily recognizes information related to buildings outside the vehicle.

However, with the technology of Unexamined Japanese Patent Publication No. 2006-242859, it is difficult to recognize a correspondence relation between the graphic object and the buildings outside the vehicle in a real environment. Therefore, the driver may misrecognize the information of the displayed graphic object as the information of a building which does not corresponds to the graphic object. That is, the conventional art has a problem that it is difficult to recognize at a glance a relation between a graphic object and an object which is targeted by information represented by the graphic object.

### SUMMARY

The present disclosure provides an information display apparatus and the like which can make a user recognize at a glance a relation between a graphic object and an object in a real environment which is targeted by information represented by the graphic object.

An information display apparatus of the present disclosure includes: a display unit on which a graphic object is displayed to be superimposed on a real environment; a first detector which detects a current position of the information display apparatus and a direction in which the real environment is located when viewed from the information display apparatus at the current position; an acquisition unit which acquires area information related to an area including the detected current position; a generation unit which generates (i) a first graphic object for providing guidance to a user about areas around the detected current position, based on the area information, the detected current position, and the detected direction and which generates (ii) for each of a plurality of first areas into which an area of the first graphic object is divided, distance information indicating a first distance which is determined based on the area information and which is a distance to be used for the first graphic object and is a distance, in the direction, from the information display apparatus; a second detector which detects, for each of a plurality of second areas in the real environment corresponding to the plurality of first areas, a second distance which is a distance, in the direction, from the information display apparatus to the real environment; a comparator which compares, for each of the first areas, the first distance of the first area indicated by the distance information with the second distance detected for a second area corresponding to the first area; and a display controller which (i) generates, based on a result of comparison by the comparator, a second graphic object from the first graphic object by removing a first area, which is one of the plurality of first areas, the first distance of which is more distant, in the direction, from the information display apparatus than the second distance is and which (ii) displays the second graphic object on the display unit.

An information display apparatus of the present disclosure can make a user recognize at a glance a relation between a graphic object and an object in a real environment which is targeted by information represented by the graphic object.

### BRIEF DESCRIPTION OF DRAWINGS

FIG. 1 is an outer appearance of a periphery of a driver's seat of a vehicle equipped with an information display apparatus according to a first exemplary embodiment.

FIG. 2 is a block diagram showing a configuration of the information display apparatus according to the first exemplary embodiment.

FIG. 3 is a flowchart for describing an operation of the information display apparatus according to the first exemplary embodiment.

FIG. 4 is a diagram for describing a positional relationship among an object in a real environment, a graphic object, and a vehicle, where the graphic object is displayed in such a manner that a user can recognize the graphic object to be superimposed on the real environment.

FIG. 5 is a diagram for describing a process of calculating first distance information and second distance information and a process of comparing a first distance with a second distance.

FIG. 6 is a diagram for describing the real environment and a generated second graphic object.

FIG. 7 is a block diagram showing a configuration of an information display apparatus according to a second exemplary embodiment.

FIG. 8 is a flowchart for describing an operation of the information display apparatus according to the second exemplary embodiment.

FIG. 9 is a diagram for describing a second graphic object which is displayed when a process of the information display apparatus according to the second exemplary embodiment is performed.

FIG. 10 is a block diagram showing a configuration of an information display apparatus according to a third exemplary embodiment.

FIG. 11 is a flowchart for describing an operation of the information display apparatus according to the third exemplary embodiment.

FIG. 12 is a diagram for describing a third graphic object which is displayed when a process of the information display apparatus according to the third exemplary embodiment is performed.

FIG. 13A is an outer appearance view showing another example of an information display apparatus according to another exemplary embodiment.

FIG. 13B is an outer appearance view showing another example of an information display apparatus according to another exemplary embodiment.

### DESCRIPTION OF EMBODIMENTS

In the following, exemplary embodiments will be described in detail with appropriate reference to the drawings. However, an unnecessarily detailed description will not be described in some cases. For example, in some cases, already well-known matters will not be described in detail, and substantially identical configurations will not be described again. This is to avoid the following description from being unnecessarily redundant and thus to help those skilled in the art to easily understand the description.

Note that the inventor provides the accompanying drawings and the following description to facilitate those skilled in the art to sufficiently understand the present disclosure, and the inventor does not intend to use the drawings or description to limit the subject matters of the claims.

### First Exemplary Embodiment

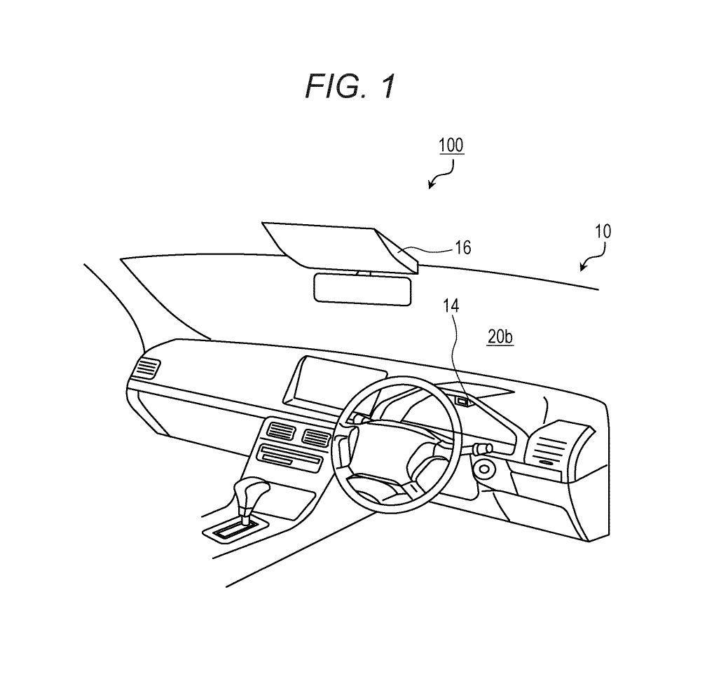

In the following, a first exemplary embodiment will be described with reference to FIGS. 1 to 6.

### [1-1. Configuration]

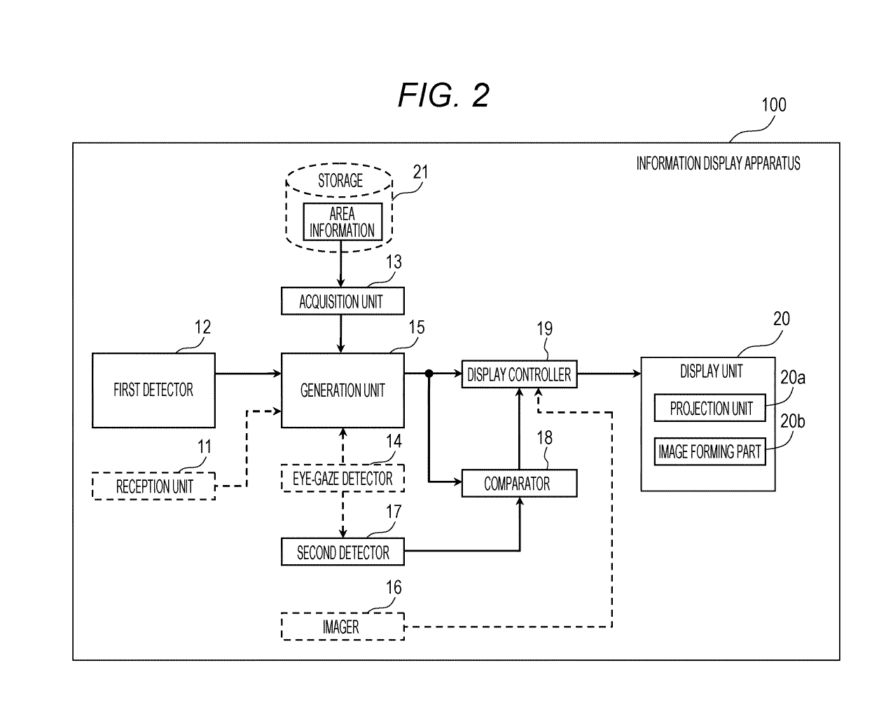

FIG. 1 is an outer appearance view of a periphery of a driver's seat of vehicle 10 equipped with information display apparatus 100 according to the first exemplary embodiment. FIG. 2 is a block diagram showing a configuration of information display apparatus 100 according to the first exemplary embodiment.

As shown in FIG. 2, information display apparatus 100 is equipped with reception unit 11, first detector 12, acquisition unit 13, eye-gaze detector 14, generation unit 15, imager 16, second detector 17, comparator 18, display controller 19, display unit 20, and storage 21. Information display apparatus 100 is implemented as, for example, a car navigation system to be installed on vehicle 10.

Reception unit 11 receives from a user an input indicating a destination. Specifically, reception unit 11 receives destination information having been input by the user of vehicle 10, where the destination information includes a destination name of the destination of the vehicle and a phone number of the destination. Reception unit 11 transfers the input destination information indicating the destination to generation unit 15.

First detector 12 detects a current position of information display apparatus 100 and a direction in which a real environment is located when viewed from information display apparatus 100 at the current position. First detector 12 transfers to generation unit 15 information indicating the detected current position of information display apparatus 100 (vehicle 10) and the detected direction in which information display apparatus 100 (vehicle 10) is facing. Note that, the direction in which information display apparatus 100 is facing may be, for example, the direction in which the front face (that is, a front part) of vehicle 10 is facing, or may be a traveling direction of vehicle 10. Note that, the direction in which information display apparatus 100 is facing is hereinafter referred to as a “traveling direction”. First detector 12 is implemented by, for example, a GPS (Global Positioning System) receiver, a geomagnetic sensor, a gyroscope (which are not shown), or the like.

Storage 21 stores area information. The area information is map information containing building information, road information, and the like. The map information is information used on a car navigation system or the like, and is information to be used to calculate a route for guiding the user from a current location to the destination. Storage 21 is implemented by, for example, a hard disk, a nonvolatile memory, or the like.

Acquisition unit 13 acquires from storage 21 the area information related to the area including the current position detected by first detector 12. Acquisition unit 13 specifically acquires from storage 21 the map information as the area information. Acquisition unit 13 is implemented by, for example, a processor, a program, and the like.

Eye-gaze detector 14 detects an eye-gaze direction of the user of vehicle 10. Specifically, Eye-gaze detector 14 takes images of an eye of the user of vehicle 10, and analyses the position, movement of the crystalline lens, and the like of the eye of the user so as to detect the eye-gaze direction in which the user is gazing Eye-gaze detector 14 transfers the detected eye-gaze direction of the user of vehicle 10 to generation unit 15 and second detector 17. Eye-gaze detector 14 is implemented by, for example, a camera such as a CCD (Charge Coupled Device) camera installed in a vehicle cabin, a processor, a program, and the like.

Generation unit 15 generates, at an appropriate position on display unit 20 in the eye-gaze direction of the user of vehicle 10, a first graphic object for providing the user of vehicle 10 with guidance of areas around the current position at which information display apparatus 100 (vehicle 10) is located, based on the area information acquired by acquisition unit 13, the current position and the traveling direction of information display apparatus 100 (vehicle 10) detected by first detector 12, the destination information received by reception unit 11, and the eye-gaze direction of the user of vehicle 10 detected by eye-gaze detector 14. Further, for each of a plurality of first areas into which a display area of the first graphic object is divided, generation unit 15 generates distance information indicating a first distance, where the first distance is determined by using the area information, is to be used for the first graphic object, and is a distance, in the traveling direction, from information display apparatus 100. Note that, the distance from information display apparatus 100 may be the distance with respect to a display surface (that is, image forming part 20b to be described later) of display unit 20 of information display apparatus 100, or may be the distance with respect to a stereo camera (see the description later) which implements second detector 17. Specifically, based on the map information, the current position and the traveling direction of vehicle 10, and the destination information, generation unit 15 generates the first graphic object for showing the route from the current location to the destination, and generates first distance information indicating the first distances at which the first graphic object is to be displayed. Note that, each of the first areas may be, for example, each of a plurality of pixels constituting the first graphic object, or may be each of groups each made up of predetermined number of pixels.

Generation unit 15 transfers the generated first graphic object to display controller 19, and the first distance information of the first graphic object to comparator 18. Generation unit 15 is implemented by, for example, a processor, a program, and the like.

Imager 16 takes an image of the real environment in the traveling direction. Specifically, imager 16 takes an image of an area including the real environment at least in the traveling direction. Imager 16 transfers the taken image of the real environment to display controller 19. Imager 16 may be implemented by, for example, a double-viewpoint camera installed in the vehicle cabin (or outside the vehicle cabin), or may be implemented by a single-viewpoint camera.

Second detector 17 detects a second distance which is a distance, in the traveling direction, from information display apparatus 100 to the real environment, for each of a plurality of second areas in the real environment corresponding to the plurality of first areas. Note that, the distance from information display apparatus 100 to the real environment may be a distance to an object in the real environment with respect to the display surface of display unit 20 of information display apparatus 100 (that is, image forming part 20b to be described later), or may be a distance of an object in the real environment with respect to a stereo camera (see the description later) which implements second detector 17. Note that, in the case where the real environment is a space in which there is no object, the distance from information display apparatus 100 to the real environment is, for example, infinity Further, the second areas are areas of display unit 20 on which the first graphic object is displayed and superimposed on the real environment which can be seen through display unit 20 from the user.

Second detector 17 may detect as the second distances the distances only from information display apparatus 100 to the object located in the traveling direction in the real environment ahead in the eye-gaze direction detected by eye-gaze detector 14.

Specifically, second detector 17 is a stereo camera having two imagers for taking images of a real environment in the traveling direction. Second detector 17 detects second distances, based on a disparity between a first image taken by one imager and a second image taken by the other imager.

Second detector 17 transfers second distance information indicating the detected second distances to comparator 18. Second detector 17 is implemented by, for example, a double-viewpoint CCD camera (stereo camera) installed outside the vehicle cabin, a processor, a program, and the like. However, second detector 17 may be implemented by a millimeter-wave radar.

Comparator 18 compares, for each of the plurality of first areas, one of the first distances, in the each of the first areas, indicated by the first distance information generated by generation unit 15 with one of the second distances detected by second detector 17 in one of the second areas corresponding to the each of the first areas. That is, comparator 18 compares, for each of the plurality of first areas, one of the first distances in a predetermined one of the first areas with one of the second distances in one of the plurality of second areas corresponding to the predetermined one of the first areas. Comparator 18 transfers the result of the comparison to display controller 19.

More specifically, in the area in which the first graphic object to be displayed and the object in the real environment seen by the user of vehicle 10 overlap each other on display unit 20, comparator 18 compares the distances of the first graphic object and the object from the information display apparatus 100 on a pixel-by-pixel basis. Then, comparator 18 transfers to display controller 19 pixel information indicating the pixel at which the first graphic object is more distant (in other words, a deeper position or a farther position) than the object in the real environment seen by the user of vehicle 10 is. Comparator 18 is recognized by, for example, a processor, a program, and the like.

Based on the result of the comparison by comparator 18, display controller 19 generates a second graphic object in which the first graphic object is removed of a first area which is in the plurality of first areas (the display area of the first graphic object) and in which the first distance is more distant (that is, more deeper) from information display apparatus 100 than the second distance is; and then the display controller 19 displays the second graphic object on display unit 20. More specifically, based on the pixel information received from comparator 18, display controller 19 generates the second graphic object in which the first graphic object is removed of a pixel at which the first graphic object is deeper than the object in the real environment seen by the user of vehicle 10; and then display controller 19 displays the generated second graphic object on display unit 20. Obviously, display controller 19 displays the first graphic object on the display unit 20 as it is in the case where the result of the comparison shows that, in no area, the first distance is more distant from information display apparatus 100 than the second distance is. Display controller 19 is implemented by, for example, a processor, a program, and the like.

On display unit 20, a graphic object is displayed to be superimposed on the real environment. Display unit 20 displays the second graphic object generated by display controller 19. Display unit 20 includes, for example, projection unit 20a which projects an image, and image forming part 20b which is formed of a transparent member in a panel shape and on which the image projected by projection unit 20a is formed. That is, on display unit 20, the second graphic object is displayed as an image which is superimposed on the real environment seen through image forming part 20b. Projection unit 20a is implemented by, for example, a projector for projecting an image including a graphic object or by other components. In addition, image forming part 20b is implemented by, for example, a windshield, or the like.

### [1-2. Operation]

An operation of information display apparatus 100 configured as above will be described below.

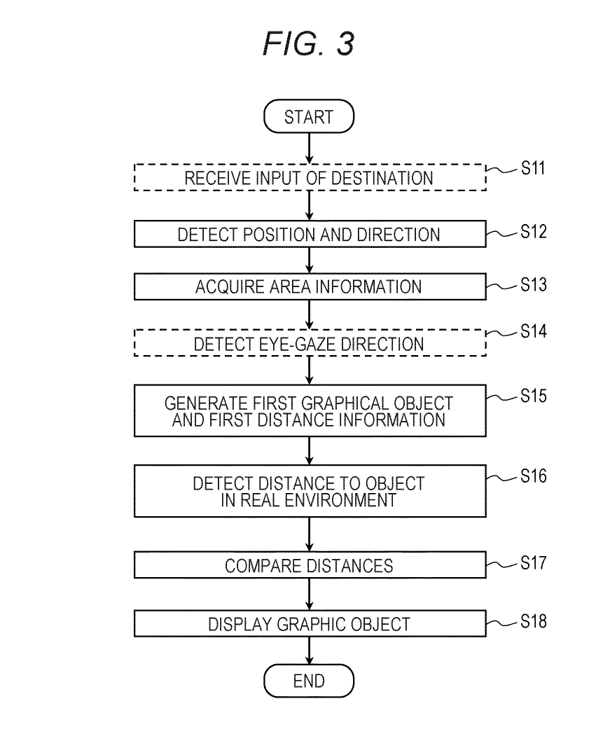

FIG. 3 is a flowchart for describing the operation of information display apparatus 100 according to the first exemplary embodiment.

First, reception unit 11 receives destination information having been input by a user of vehicle 10, where the destination information includes a destination name indicating a destination and a phone number, and reception unit 11 transfers the received destination information to generation unit 15 (step S11).

Next, first detector 12 detects a current position and a traveling direction of information display apparatus 100 (vehicle 10), and transfers to generation unit 15 the information indicating the detected current position and the traveling direction (step S12).

Next, acquisition unit 13 acquires area information from storage 21, and transfers the acquired area information to generation unit 15 (step S13).

Next, eye-gaze detector 14 detects an eye-gaze direction of the user, and transfers the detected eye-gaze direction to generation unit 15 and second detector 17 (step S14).

Next, generation unit 15 generates, based on the area information, the current position, the traveling direction, and the eye-gaze direction which have been received, a first graphic object for providing guidance to a user about areas around information display apparatus 100, and generation unit 15 generates distance information indicating a first distance for each of a plurality of first areas into which an area of the first graphic object is divided into, where the first distance is determined by using the area information and is a distance to be used for the first graphic object, and the first distance is a distance from information display apparatus 100 in the traveling direction. Further, generation unit 15 transfers the generated first graphic object to display controller 19, and transfers the generated first distance information to comparator 18 (step S15).

Next, for each of a plurality of second areas in the real environment corresponding to each of the plurality of first areas, second detector 17 detects a second distance which is a distance, in the traveling direction, from information display apparatus 100 to the real environment; and second detector 17 transfers the second distance information indicating the second distance to comparator 18 (step S16). More specifically, second detector 17 detects as the second distance only the received distance to the object ahead in the eye-gaze direction in the real environment.

Comparator 18 compares the received first distance information with the received second distance information, and transfers the result of the comparison to display controller 19 (step S17). More specifically, based on the first distance information and the second distance information, comparator 18 compares the first graphic object with the object in the real environment seen by the user of vehicle 10 on a pixel-by-pixel basis in the area in which the first graphic object and the object in the real environment seen by the user of vehicle 10 overlap each other; thus, comparator 18 transfers to display controller 19 pixel information indicating a pixel at which the first graphic object is determined to be more distant from information display apparatus 100 than the object in the real environment seen by the user of vehicle 10 is.

Based on the result of the comparison by comparator 18, display controller 19 generates a second graphic object in which the first graphic object is removed of an area which is in the areas of the first graphic object and in which the first distance is determined to be more distant from information display apparatus 100 than the second distance is; and display controller 19 displays the second graphic object on display unit 20 (step S18). More specifically, based on the received pixel information, display controller 19 generates a second graphic object in which the first graphic object is removed of a pixel at which the first distance is determined to be more distant from information display apparatus 100 than the second distance is; and display controller 19 displays the second graphic object on display unit 20.

### [1-3. Specific Example]

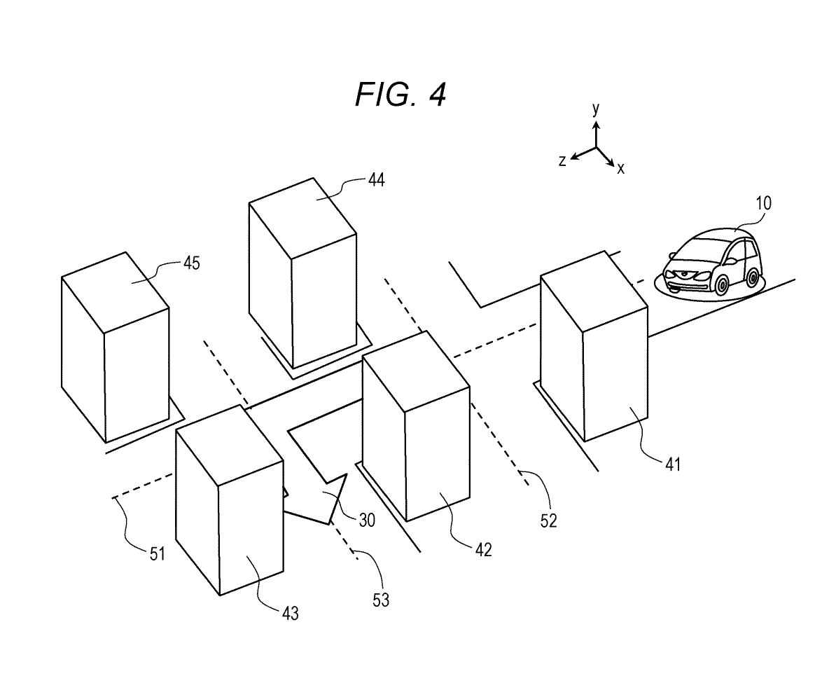

Here, a specific example of a graphic object to be displayed on display unit 20 will be described with reference to FIG. 4 to FIG. 6.

FIG. 4 is a diagram for describing a positional relationship among an object in a real environment, a graphic object, and a vehicle, where the graphic object is displayed in such a manner that a user can recognize the graphic object superimposed on the real environment. Note that, in FIG. 4, the traveling direction of vehicle 10 is the Z-axis direction, the vertical direction is the Y-axis direction, and the direction perpendicular to the Z-axis direction and the Y-axis direction is the X-axis direction.

In the real environment of the example shown in FIG. 4, buildings 41 to 45 are located in the traveling direction of vehicle 10. Further, among buildings 41 to 45, roads 51 to 53 are extending in the X-axis direction and the Z-axis direction. Suppose that a route calculated corresponding to a destination having been input by a user is a route going straight on road 51 and turning to the left on mad 53 between building 42 and building 43. In this case, generation unit 15 generates a first graphic object corresponding to a guidance to turn to the left on the road between building 42 and building 43, as shown by arrow 30. As shown in FIG. 4, this arrow 30 has such a length in the Z-axis direction that, at the position of road 53, arrow 30 is located at a position most distant from vehicle 10. In other words, since arrow 30 has a depth when viewed from vehicle 10, generation unit 15 generates the first graphic object representing such arrow 30 and generates first distance information indicating a distance, in the Z-axis direction, from information display apparatus 100 for each of a plurality of pixels constituting the first graphic object.

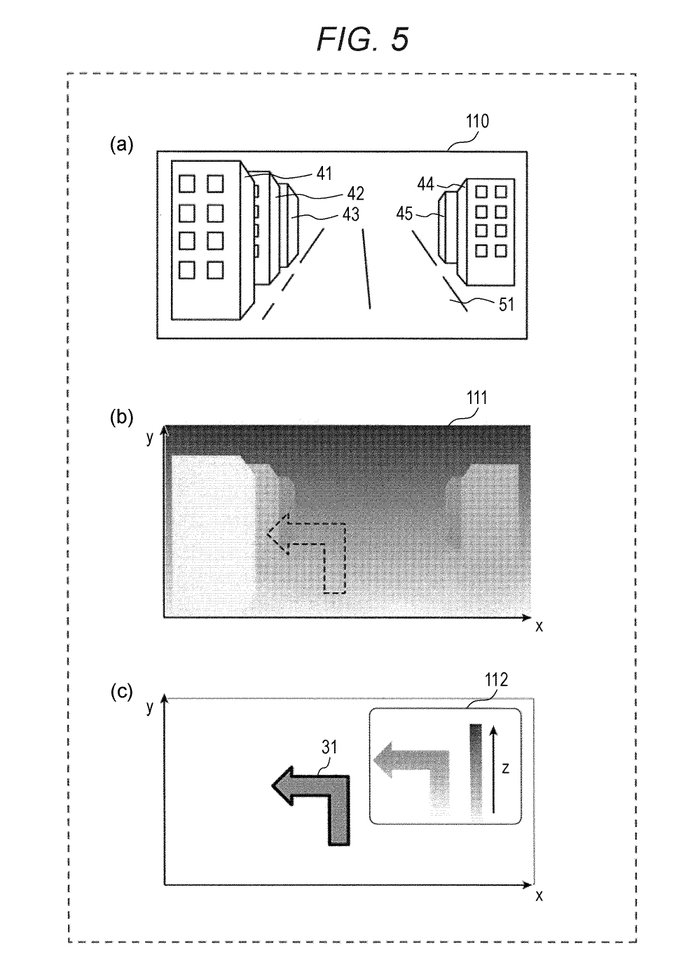

FIG. 5 is a diagram for describing a process of calculating the first distance information and the second distance information and a process of comparing the first distance with the second distance. Specifically, reference mark (a) in FIG. 5 is a diagram showing real environment 110 ahead of vehicle 10 which can be seen from a driver's seat of vehicle 10. Reference mark (b) in FIG. 5 is a diagram showing second distance information 111 showing the second distances detected by second detector 17. Reference mark (c) in FIG. 5 is a diagram showing first graphic object 31 generated by generation unit 15.

As shown in reference mark (b) in FIG. 5, second detector 17 generates second distance information 111 indicating the second distances, based on a disparity between the first image taken by one imager and the second image taken by the other imager. Second distance information 111 shows the distances in such a manner that the darker color indicates being more distant from information display apparatus 100 (in other words, having a larger distance) and that the lighter color indicates being closer to information display apparatus 100 (in other words, having a smaller distance).

Further, as shown in reference mark (c) in FIG. 5, generation unit 15 generates first graphic object 31 together with the first distance information 112 indicating the first distances at which first graphic object 31 is displayed. First distance information 112 shows the distances in the same way as second distance information 111 in such a manner that the darker color indicates the graphic object to be displayed at a position more distant from information display apparatus 100 and that the lighter color indicates the graphic object to be displayed at a position closer to information display apparatus 100. Note that first distance information 112 is generated based on arrow 30 shown in FIG. 4.

For each pair of pixels one of which corresponds to first distance information 112 and the other of which corresponds to second distance information 111, comparator 18 compares the first distance with the second distance, so that comparator 18 specifies all of the pixels each of which corresponds to the first distance determined to be more distant from information display apparatus 100 (i.e. larger) than the second distance is. Note that comparator 18 has only to compare the first distance with the second distance of the second distance information 111, in the area in which first graphic object 31 is to be displayed (for example, the area defined in the X-Y coordinates).

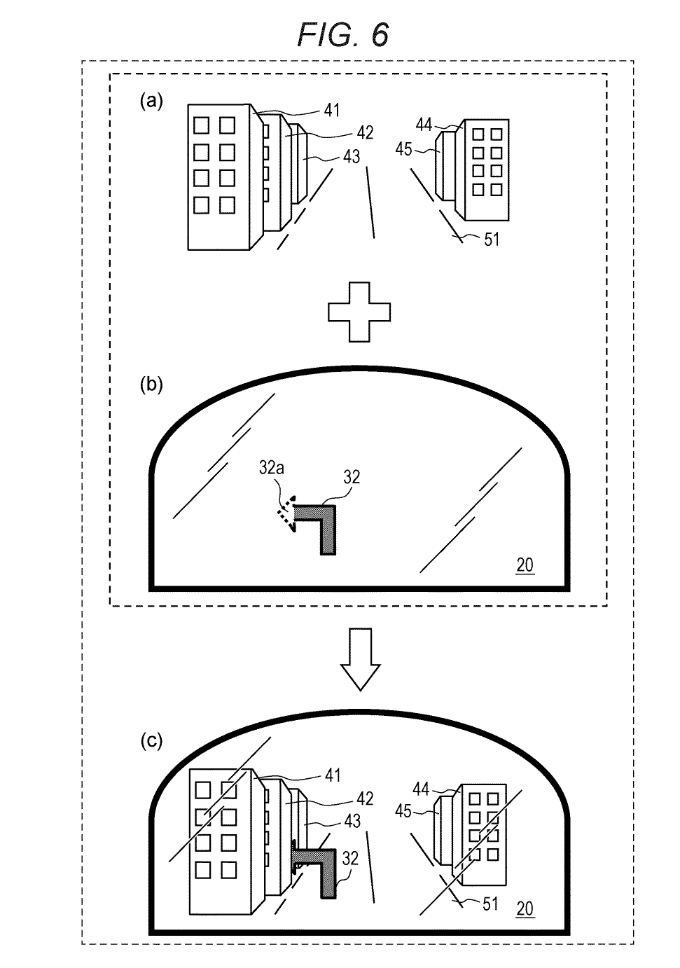

FIG. 6 is a diagram for describing the real environment and the generated second graphic object. Specifically, reference mark (a) in FIG. 6 is a diagram showing real environment 110, ahead of vehicle 10, seen from the driver's seat of vehicle 10. Reference mark (b) in FIG. 6 is a diagram showing the second graphic object displayed on display unit 20. Reference mark (c) in FIG. 6 is a diagram showing the real environment seen over the second graphic object displayed on display unit 20.

As shown in reference mark (b) in FIG. 6, display controller 19 generates second graphic object 32 in which, based on the result of the comparison by comparator 18, first graphic object 31 is removed of area 32a in which the first distances are determined to be more distant from information display apparatus 100 than the second distances is; and display controller 19 displays second graphic object 32 on display unit 20. Thus, as shown in reference mark (c) in FIG. 6, in the real environment actually seen from the driver's seat of vehicle 10 through display unit 20, second graphic object 32 is displayed to be superimposed on the real environment. Thus, the user can easily grasp that a tip of the arrow shown in second graphic object 32 is behind building 42. Therefore, the user can easily recognize that second graphic object 32 is a representation indicating a left turn toward road 53 between building 42 and building 43.

### [1-4. Advantage Effects and the Like]

As described above, in the present exemplary embodiment, information display apparatus 100 is equipped with display unit 20, first detector 12, acquisition unit 13, generation unit 15, second detector 17, comparator 18, and display controller 19. Display unit 20 displays a graphic object to be superimposed on a real environment. First detector 12 detects a current position of information display apparatus 100 and a direction (traveling direction) in which the real environment is located when viewed from information display apparatus 100 at the current position. Acquisition unit 13 acquires area information related to an area including the detected current position. Generation unit 15 generates (i) a first graphic object for providing guidance to a user about areas around the detected current position, based on the area information, the detected current position, and the detected direction; and generation unit 15 generates (ii) for each of a plurality of first areas into which an area of the first graphic object is divided, distance information indicating a first distance which is determined based on the area information and which is a distance to be used for the first graphic object and is a distance, in the direction, from the information display apparatus 100. Second detector 17 detects, for each of a plurality of second areas in the real environment corresponding to the plurality of first areas, a second distance which is a distance, in the direction, from the information display apparatus to the real environment. Comparator 18 compares, for each of the first areas, the first distance indicated by the distance information in the each of the first areas with the second distance detected in one of the second areas corresponding to the each of the first areas. Display controller 19 generates (i) based on a result of comparison by the comparator 18, a second graphic object in which the first graphic object is removed of a first area which is in the plurality of first areas and in which the first distance is more distant from the information display apparatus 100 than the second distance is, and displays (ii) the second graphic object on the display unit 20.

With information display apparatus 100 of the present disclosure, the second distance, in the traveling direction, from information display apparatus 100 to the real environment is detected; the detected second distance is compared with the first distance generated to be used for the generated first graphic object; and the second graphic object is displayed on the display unit, where the second graphic object is generated by removing from the first graphic object an area in which the first graphic object is determined to be more distant from information display apparatus 100 than the object in the real environment is. Therefore, for example, even if, not only a building but also an obstacle other than a building such as a roadside tree are at a closer position in the real environment than a graphic object to be displayed is, a graphic object is displayed which is removed of a graphic object in an area overlapping the obstacle. Therefore, the graphic object can be displayed as if the graphic object is behind the obstacle. Thus, the user can be made to recognize as if the position of the graphic object is displayed at an appropriate position in the traveling direction (depth direction) in the real environment. As a result, the user can intuitively recognize the position, in the depth direction, shown by the graphic object at the appropriate position.

Further, in the present exemplary embodiment, information display apparatus 100 is further equipped with eye-gaze detector 14 which detects an eye-gaze direction of the user. Second detector 17 detects as the second distance only the distance, in the direction, from information display apparatus 100 to the object in the real environment ahead in the eye-gaze direction.

In information display apparatus 100 of the present disclosure, since the second distance is detected on an object in the real environment as a target at which the user is gazing, it is not necessary to detect the second distance on the object in the real environment at which the user is not gazing Therefore, it is possible to reduce throughput related to detecting the second distance.

In the present exemplary embodiment, information display apparatus 100 is further equipped with reception unit 11 which receives an input indicating a destination from the user. Acquisition unit 13 acquires map information as area information. Generation unit 15 generates as first graphic object 31 a graphic object for showing the route from the current position to the destination, based on the map information, the current position, the traveling direction, and the destination indicated by the received input.

With information display apparatus 100 of the present disclosure, it is possible to generate a graphic object corresponding to the destination having been input. Therefore, it is possible to display the graphic object appropriate to the user.

In information display apparatus 100 in the present exemplary embodiment, display unit 20 is equipped with projection unit 20a and image forming part 20b. Projection unit 20a projects an image. Image forming part 20b is formed of a transparent member in a panel shape, and the image projected by the projection unit is formed on image forming part 20b.

With information display apparatus 100 of the present disclosure, since the generated image is projected by projection unit 20a on image forming part 20b to display the graphic object, the user can see the image in which the graphic object displayed on image forming part 20b is superimposed on the real environment seen through image forming part 20b. As described above, since the graphic object can be displayed to be superimposed on the real environment which the user is actually seeing, it is not necessary for the user to see the graphic object without turning his or her eyes from the real environment.

### Second Exemplary Embodiment

### [2-1. Configuration]

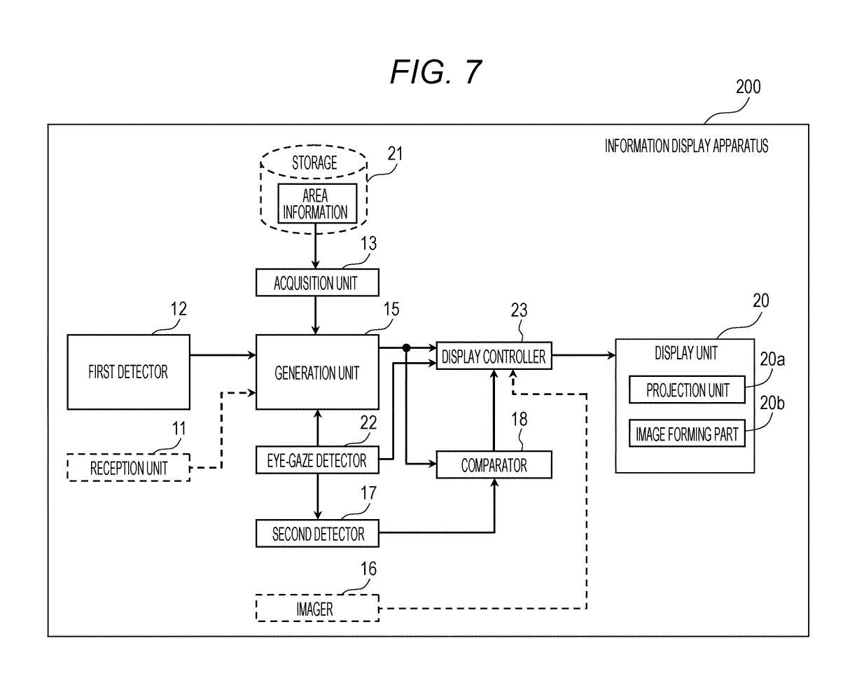

FIG. 7 is a block diagram showing a configuration of an information display apparatus 200 according to a second exemplary embodiment.

With reference to FIG. 7, the configuration of information display apparatus 200 is different from the configuration of information display apparatus 100 according to the first exemplary embodiment in the point that information display apparatus 200 is equipped with eye-gaze detector 22 and display controller 23 instead of eye-gaze detector 14 and display controller 19.

In the following, a description will be made mainly on the point in which information display apparatus 200 is different from information display apparatus 100 according to the first exemplary embodiment.

Eye-gaze detector 22 is different from eye-gaze detector 14 of the first exemplary embodiment in that eye-gaze detector 22 transfers the detected eye-gaze direction of the user of vehicle 10 to generation unit 15, and second detector 17, and further to display controller 23. Since the other functions of eye-gaze detector 22 are the same as the functions of the eye-gaze detector 14 of the first exemplary embodiment, and the description on the other functions is not made again. Eye-gaze detector 22 is implemented by, for example, a camera such as a CCD (Charge Coupled Device) camera installed in a vehicle cabin, a processor, a program, and the like.

Display controller 23 has the function of display controller 19 of the first exemplary embodiment, and in addition, has a function that, when the eye-gaze direction is directed to an area other than the area on display unit 20 in which the second graphic object is to be displayed, display controller 23 does not display the second graphic object or increases a transmittance of the second graphic object. More specifically, display controller 23 determines whether the eye-gaze direction detected by eye-gaze detector 22 is directed to the area on display unit 20 in which the second graphic object is to be displayed, and if it is determined that the eye-gaze direction is not directed to the area, display controller 23 does not display the second graphic object or increases the transmittance of the second graphic object. Since the other functions of display controller 23 are the same as the functions of display controller 19 of the first exemplary embodiment, the description on the other functions is not made again. Display controller 23 is implemented by, for example, a processor, a program, and the like.

### [2-2. Operation]

An operation of information display apparatus 200 configured as above will be described below.

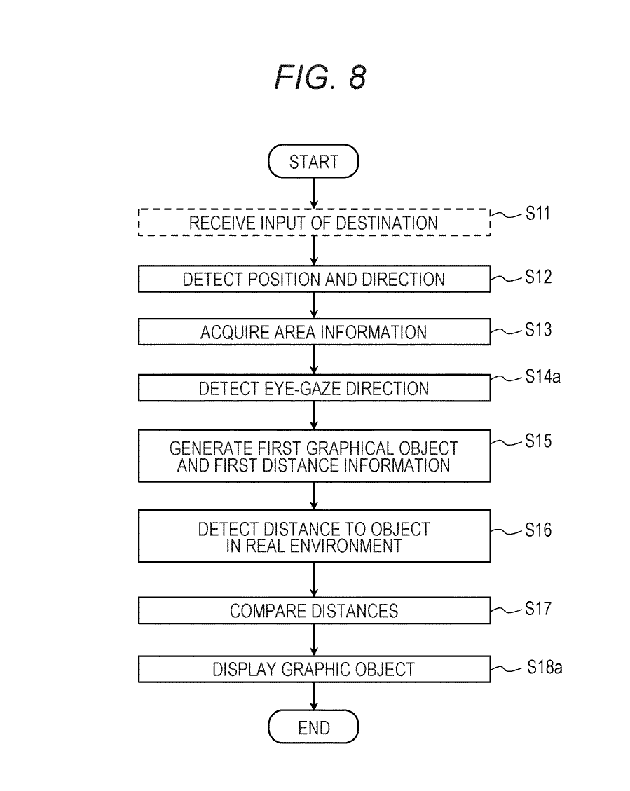

FIG. 8 is a flowchart for describing the operation of information display apparatus 200 according to the second exemplary embodiment.

With reference to FIG. 8, the operation flow of information display apparatus 200 is different from the operation flow of information display apparatus 100 according to the first exemplary embodiment in the point that the operation flow of information display apparatus 200 includes step 514a and step 518a instead of step S14 and step S18.

In the following, a description will be made mainly on the point in which the operation flow of information display apparatus 200 is different from the operation flow of information display apparatus 100 according to the first exemplary embodiment.

Eye-gaze detector 22 detects the eye-gaze direction of the user, and transfers the detected eye-gaze direction to generation unit 15 and second detector 17, and further to display controller 23 (step S14a).

In addition to the operation of step S18 in the operation flow according to the first exemplary embodiment, display controller 23 has an operation that, if the eye-gaze direction is determined to be directed to an area other than the area on display unit 20 in which the second graphic object is to be displayed, display controller 23 does not display the second graphic object or increases a transmittance of the second graphic object (step S18a).

### [2-3. Specific Example]

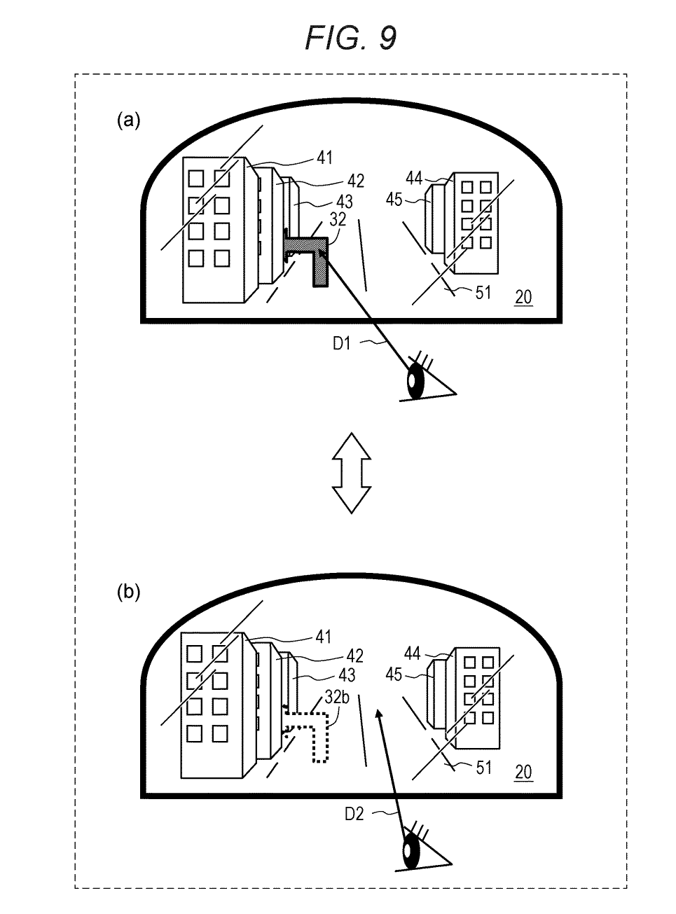

Here, a specific example of a graphic object to be displayed on display unit 20 will be described with reference to FIG. 9.

FIG. 9 is a diagram for describing a second graphic object which is displayed when a process of information display apparatus 200 according to the second exemplary embodiment is performed. Specifically, reference mark (a) in FIG. 9 is a diagram for describing second graphic object 32 displayed on display unit 20 when eye-gaze direction D1 of the user is directed to an area in which second graphic object 32 is to be displayed in a situation in which second graphic object 32 as described in reference mark (c) in FIG. 5 is to be displayed. Reference mark (b) in FIG. 9 is a diagram for describing second graphic object 32 displayed on display unit 20 when eye-gaze direction D2 of the user is directed to an area other than the area in which second graphic object 32 is to be displayed in a situation in which second graphic object 32 is to be displayed.

As shown in reference mark (a) in FIG. 9, second graphic object 32 similar to the second graphic object in reference mark (c) in FIG. 5 is displayed when eye-gaze direction D1 of the user detected by eye-gaze detector 22 is directed to the area on display unit 20 in which second graphic object 32 is to be displayed. On the other hand, as shown in reference mark (b) in FIG. 9, second graphic object 32 is not displayed, or second graphic object 32 is displayed with the transmittance of second graphic object 32 being increased, when the eye-gaze direction D2 of the user detected by eye-gaze detector 22 is directed to an area other than the area on display unit 20 in which second graphic object 32 is to be displayed. That is, broken line arrow 32b shown in reference mark (b) in FIG. 9 is the area in which second graphic object 32 is to be displayed, but broken line arrow 32b is in a situation in which second graphic object 32 is not displayed or in a situation in which second graphic object 32 is displayed with an increased transmittance.

### [2-4. Advantageous Effect and the Like]

As described above, in the present exemplary embodiment, information display apparatus 200 is equipped with display unit 20, first detector 12, acquisition unit 13, generation unit 15, second detector 17, comparator 18, eye-gaze detector 22, and display controller 23. Further, display controller 23 does not display second graphic object 32 or increases a transmittance of display of second graphic object 32 when an eye-gaze direction detected by eye-gaze detector 22 is directed to an area other than the area on display unit 20 in which second graphic object 32 is to be displayed.

With information display apparatus 200 of the present disclosure, second graphic object 32 can be displayed such that second graphic object 32 disturbs a user seeing a real environment as little as possible. Thus, it is possible to provide a proper image the user wishes to view.

### Third Exemplary Embodiment

### [3-1. Configuration]

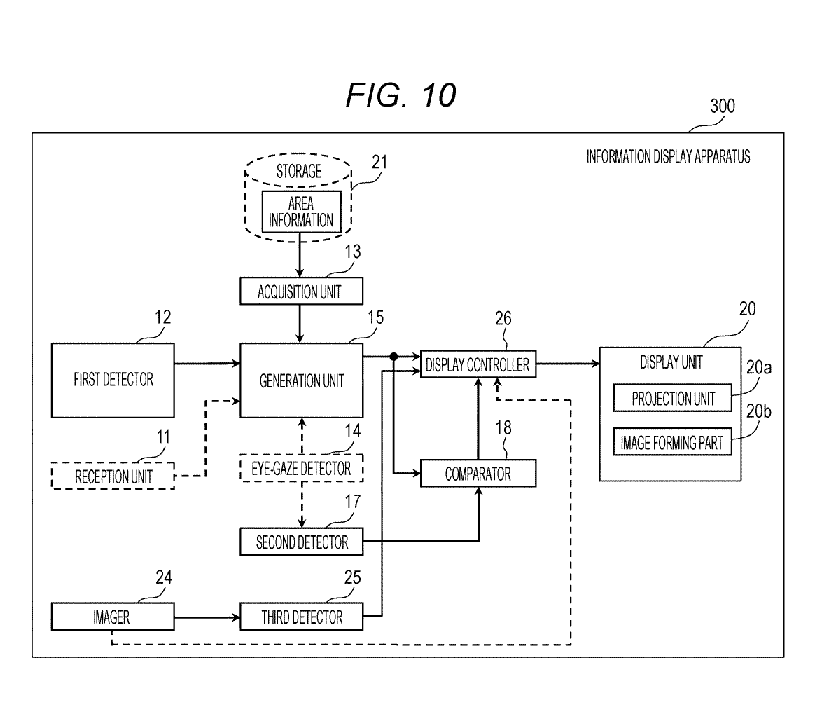

FIG. 10 is a block diagram showing a configuration of information display apparatus 300 according to a third exemplary embodiment.

With reference to FIG. 10, the configuration of information display apparatus 300 is different from the configuration of information display apparatus 100 according to the first exemplary embodiment in the point that information display apparatus 300 is equipped with imager 24, third detector 25, and display controller 26 instead of imager 16 and display controller 19.

In the following, a description will be made mainly on the point in which information display apparatus 300 is different from information display apparatus 100 according to the first exemplary embodiment.

Imager 24 is different from imager 16 of the first exemplary embodiment in that imager 24 transfers a taken image of a real environment to display controller 26, and further to third detector 25. Since the other functions of the imager 16 are the same as the functions of imager 16 of the first exemplary embodiment, the description on the other functions is not made again. Imager 24 may be implemented by, for example, a double-viewpoint camera installed in a vehicle cabin (or outside the vehicle cabin), or may be implemented by a single-viewpoint camera.

Third detector 25 detects, from the image taken by imager 24, a moving object area in which an object moving in the real environment is imaged. In other words, third detector 25 detects an object moving in the image by performing image processing on the taken image. As described above, third detector 25 generates the moving object area, based on the image taken by imager 24 and the eye-gaze direction of the user of vehicle 10, so as to make the user of vehicle 10 see the moving object on the display unit 20. Note that, third detector 25 does not have to detect all of the objects moving in the taken image, and instead, third detector 25 may detect, for example, only an object moving in a direction different from the traveling direction of vehicle 10. Here, the direction different from the traveling direction may be the direction different from the traveling direction by a predetermined angle or more. That is, the direction 180 degrees different from the traveling direction (the direction toward vehicle 10) may be included in the direction different from the traveling direction. Third detector 25 transfers the generated moving object area to display controller 26. Third detector 25 is implemented by, for example, a processor, a program, and the like.

Display controller 26 has the function of display controller 19 of the first exemplary embodiment, and in addition, generates a third graphic object in which the second graphic object is removed of an area which is in the area of the second graphic object and which corresponds to the detected moving object area; and display controller 26 displays the third graphic object on display unit 20. In other words, regardless of the result of the comparison by comparator 18, display controller 26 controls the display of the graphic object so that the real environment in the moving object area can be seen, from the user of vehicle 10, in the area in which the second graphic object and the detected moving object area overlap each other. Obviously, if a moving object area is not detected by third detector 25, display controller 26 displays the second graphic object on display unit 20 as it is. Display controller 26 is implemented by, for example, a processor, and program, and the like.

### [3-2. Operation]

An operation of information display apparatus 300 configured as above will be described below.

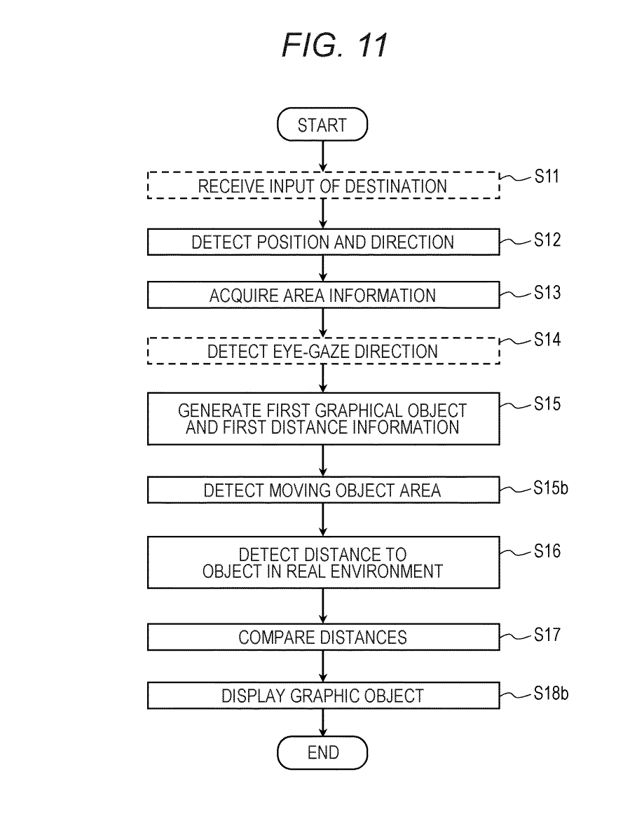

FIG. 11 is a flowchart for describing an operation of information display apparatus 300 according to the third exemplary embodiment.

With reference to FIG. 11, the operation flow of information display apparatus 300 is different from the operation flow of information display apparatus 100 according to the first exemplary embodiment in the point that the operation flow of information display apparatus 300 further includes step S15b and includes step S18b instead of step S18.

In the following, a description will be made mainly on the point in which the operation flow of information display apparatus 300 is different from the operation flow of information display apparatus 100 according to the first exemplary embodiment.

Third detector 25 detects, from the image of the real environment in the traveling direction taken by imager 24, a moving object area in which an object moving in the real environment is imaged; and third detector 25 transfers the detected moving object area to display controller 26 (step S15b).

Display controller 26 performs the operation of step S18 of the operation flow according to the first exemplary embodiment, and in addition, further generates a third graphic object in which the second graphic object is removed of an area which is in the area of the second graphic object and corresponds to the detected moving object area; and display controller 26 displays the third graphic object on display unit 20 (step S18b).

### [3-3. Specific Example]

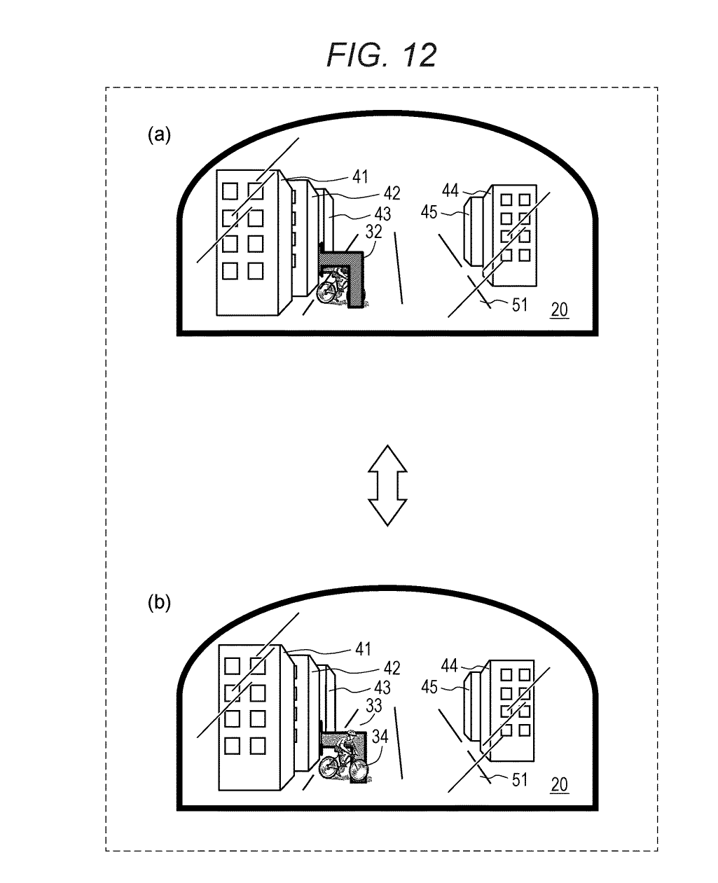

Here, a specific example of the graphic object to be displayed on display unit 20 will be described with reference to FIG. 12.

FIG. 12 is a diagram for describing third graphic object 33 which is displayed when the process of information display apparatus 300 according to the third exemplary embodiment is performed. Specifically, reference mark (a) in FIG. 12 is a diagram for describing second graphic object 32 which is displayed if the process by display controller 26 is not performed in a situation that second graphic object 32 shown in reference mark (c) in FIG. 5 is to be displayed and that a moving object is detected. Reference mark (b) in FIG. 12 is a diagram for describing third graphic object 33 which is displayed when the process by display controller 26 is performed in a situation that second graphic object 32 is to be displayed and that a moving object is detected.

As shown in reference mark (a) in FIG. 12, in a situation that a moving object is detected, second graphic object 32 is displayed overlapping the moving object.

Therefore, if second graphic object 32 is displayed as it is in such a situation, it is difficult for a user to visually recognize the moving object.

On the other hand, as shown in reference mark (b) in FIG. 12, in the situation that a moving object is detected, an area of the moving object is detected as moving object area 34, third graphic object 33 is generated in which second graphic object 32 corresponding to detected moving object area 34 is removed, and the third graphic object 33 is displayed on display unit 20. Thus, a graphic object can be displayed in an area from which the moving object area corresponding to the moving object is removed, so that the user can visually recognize the moving object with ease even in the case where the graphic object is overlapping the moving object.

### [3-4. Advantageous Effects and the Like]

As described above, in the present exemplary embodiment, information display apparatus 300 is equipped with display unit 20, first detector 12, acquisition unit 13, generation unit 15, second detector 17, comparator 18, and display controller 26. Information display apparatus 300 is further equipped with imager 24 and third detector 25. Imager 24 takes an image of a real environment in a traveling direction. Third detector 25 detects from an image taken by imager 24 a moving object area in which an object moving in the real environment is imaged. Display controller 26 further generates third graphic object 33 in which second graphic object 32 is removed of an area which is in the area of second graphic object 32 and corresponds to detected moving object area 34; and display controller 26 displays third graphic object 33 on display unit 20.

With information display apparatus 300 of the present disclosure, in the case where a real environment includes moving objects such as another vehicle, a bicycle, and a pedestrian which are crossing a road, it is possible to prevent second graphic object 32 displayed on display unit 20 from hiding the object as much as possible. Therefore, it is possible to facilitate a user to pay attention to the moving object.

In the present exemplary embodiment, second detector 17 of information display apparatus 300 is a stereo camera having two imagers which take images of the real environment in the traveling direction. Further, second detector 17 detects a second distance, based on a disparity between a first image taken by one imager and a second image taken by the other imager.

With information display apparatus 300 of the present disclosure, it is possible to detect a distance to an object in a real environment while taking images of a real environment in the traveling direction; therefore, it is possible to detect, for example, a pedestrian crossing in the traveling direction without installing a camera for separately taking an image That is, the cameras implementing second detector 17 and imager 24 do not have to be separate cameras, and can be a commonly used camera.

### Other Exemplary Embodiments

In the above, the first to third exemplary embodiments are described as examples of the technology disclosed in the present application. However, the technology of the present disclosure is not limited to the above examples and can apply to an exemplary embodiment on which modification, replacement, addition, removal, and the like have been appropriately made. Further, it is possible to combine the components disclosed in the first to third exemplary embodiments to make a new exemplary embodiment.

In view of the above, other exemplary embodiments will be described below.

Information display apparatuses 100, 200, 300 according to the first to third exemplary embodiments are equipped with reception unit 11; however, the information display apparatuses do not need to be equipped with reception unit 11. That is, even in the case where an information display apparatus is not equipped with reception unit 11, it is possible to establish a function equivalent to the functions of information display apparatus 100, 200, 300 if the information display apparatus is configured to previously obtain information about areas around the information display apparatus and to display the information as a graphic object.

Information display apparatuses 100, 200, 300 according to the first to third exemplary embodiments are equipped with storage 21; however, the information display apparatuses do not need to be equipped with storage 21. That is, even if information display apparatuses 100, 200, 300 are not equipped with storage 21, the information display apparatuses may obtain area information from a server over the internet or may obtain area information from an externally provided storage device which stores area information. With this arrangement, even if an information display apparatus is not equipped with storage 21, the information display apparatus can establish a function equivalent to the functions of information display apparatuses 100, 200, 300.

Information display apparatuses 100, 300 according to the first and third exemplary embodiments are equipped with eye-gaze detectors 14, 22; however, the information display apparatuses do not need to be equipped with eye-gaze detectors 14, 22. Information display apparatus 100, 300 determine, based on the eye-gaze direction detected by eye-gaze detectors 14, 22, the position of the display surface of display unit 20 on which a graphic object is displayed on display unit 20; however, even in the case where the eye-gaze direction is not detected, the eye-gaze direction can be calculated if it is known that a user in vehicle 10 is at a predetermined fixed position; thus, it is possible to establish a function equivalent to the function of information display apparatus 100.

Further, in order to reduce throughput, information display apparatuses 100, 300 detects as the second distance only the distance, in the direction detected by first detector 12, from information display apparatus 100 to an object in the real environment ahead in the eye-gaze direction detected by eye-gaze detectors 14, 22, (that is, an object which the user is seeing). In the case where the eye-gaze direction is not detected, the throughput cannot be reduced; however, except this function, it is possible to establish a function equivalent to the functions of information display apparatus 100, 300.

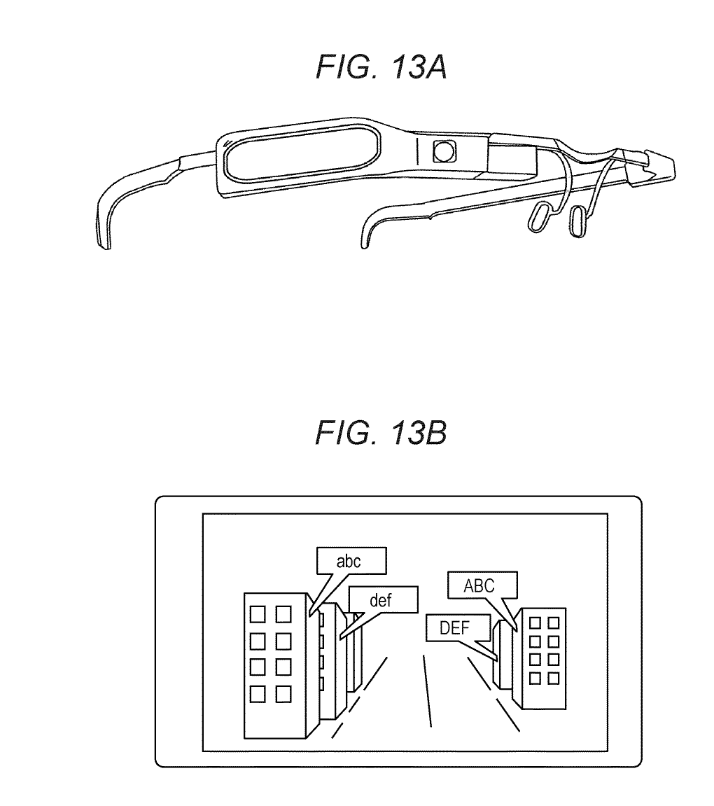

In information display apparatuses 100, 200, 300 according to the first to third exemplary embodiments, generation unit 15 does not aggressively superimpose a first graphic object on the object, in the real environment, corresponding to the first graphic object when generating the first graphic object; however, generation unit 15 may generate first graphic object such that the first graphic object is superimposed on the object in the real environment. Specifically, generation unit 15 may generate the first graphic object such that two areas overlap at least partly each other, where one of the two areas is an area in which the first graphic object is displayed on display unit 20; the other of the two areas is an area in which an object in the real environment is visible on display unit 20; and the object in the real environment is a target which the first graphic object is showing. More specifically, for example, as shown in FIG. 13B, a first graphic object as an annotation display (including a sign of tourist information, description, comment, and the like) of a building may be generated such that a tip part of the first graphic object overlaps the object in the real environment such as a building and such that the area of the tip part overlapping the object is removed. Obviously, the first graphic object may be generated such that, for example, the first graphic object in the first exemplary embodiment is made to aggressively overlap the object in the real environment. With this arrangement, it is possible for the user to visually recognize at a glance the correspondence relation between the object as a target which the first graphic object is showing and the second graphic object generated based on the first graphic object.

Information display apparatuses 100, 200 according to the first and second exemplary embodiments are equipped with imager 16; however, information display apparatuses 100, 200 do not need to be equipped with imager 16. Information display apparatuses 100, 200 use an image in which a real environment is imaged in order to determine the position on the display surface of display unit 20 at which the graphic object is to be displayed; however, even in the case where the image is not taken, it is possible to estimate the real environment visible to the user if the current position and the traveling direction of vehicle 10 are detected. Therefore, it is possible to establish a function equivalent to the function of information display apparatus 100.

In information display apparatuses 100, 200, 300 according to the first to third exemplary embodiments, display unit 20 includes projection unit 20a and image forming part 20b; however, information display apparatuses 100, 200, 300 are not limited to the above exemplary embodiments and may include a display such as a liquid crystal display and an organic EL display. Specifically, in information display apparatuses 100, 200, 300, the user can see the real environment and the graphic object to be superimposed through a windshield since the graphic object is projected on the windshield as image forming part 20b; however, the configuration is not limited to the above, and it is possible to display, on the display, the image of the real environment taken by imager 16 and the graphic object superimposed on the image. Also with this configuration, the user can see the image in which the images of the real environment and the graphic object are superimposed. Further, in this case, imager 16 for taking an image of a real environment is an essential component.

Examples are described in which information display apparatuses 100, 200, 300 according to the first to third exemplary embodiments are implemented as car navigation systems; however, information display apparatuses 100, 200, 300 may be implemented not only as a car navigation system but also as eyeglass-type wearable terminals shown in FIG. 13A or as tablet terminals (or smartphone) shown in FIG. 13B.

In information display apparatuses 100, 200, 300 according to the first to third exemplary embodiments, area information is map information; however, the area information may include not only information of maps but also information related to landmarks such as buildings, monuments, open spaces (squares), nature. Note that, the information related to landmarks may be a name of a landmark or a description describing a history of a landmark. That is, in this case, instead of a graphic object for showing the route from a current location to a destination, information related to a landmark may be displayed in an area corresponding to the landmark as shown in FIG. 13B.

Note that, in the first to third exemplary embodiments, each component may be configured with a dedicated hardware or may be implemented by executing a software program appropriate to the each component. Each component may also be implemented by a central processing unit (CPU) or a program executing unit such as a processor which reads out and executes a software program stored in a recording medium such as a hard disk or a semiconductor memory. Here, a software which implements image decoding devices and the like in the above exemplary embodiments is a program described below.

That is, the program causes a computer to execute a method for displaying information in an information display apparatus which is equipped with a display unit on a display surface of which a graphic object is displayed to be superimposed on a real environment. The method includes: detecting a current position of the information display apparatus and a direction in which the real environment is located when viewed from the information display apparatus at the current position; acquiring area information related to an area including the detected current position; generating (i) a first graphic object for providing guidance to a user about areas around the current position, based on the acquired area information, the detected current position, and the detected direction and (ii) for each of a plurality of first areas into which an area of the first graphic object is divided, distance information indicating a first distance which is determined based on the area information and which is a distance to be used for the first graphic object and is a distance from the display surface; detecting, for each of a plurality of second areas in the real environment corresponding to the plurality of first areas, a second distance which is a distance, in the direction, from the display surface to the real environment; comparing, for each of the first areas, the first distance indicated by the distance information in the each of the first areas with the second distance detected in one of the second areas corresponding to the each of the first areas; (i) generating, based on a result of comparison, a second graphic object in which the first graphic object is removed of a first area which is in the plurality of first areas and in which the first distance is more distant, in the direction, from the display surface than the second distance is; and (ii) displaying the second graphic object on the display unit.

The exemplary embodiments are described above as examples of the technology in the present disclosure. For that purpose, the accompanying drawing and the detailed description are provided.

Therefore, the components described in the accompanying drawings and in the detailed description include components necessary for solving the problems, but in addition, in order to exemplify the above implementation, the components can also include components unnecessary for solving the problems. For this reason, it should not be immediately recognized that those unnecessary components are necessary, based on the fact that those unnecessary components are described in the accompanying drawings and the detailed description.

In addition, because the above exemplary embodiments are for exemplifying the technology in the present disclosure, various modifications, replacements, additions, or removals can be made without departing from the scope of the accompanying claims or the equivalent thereof.

The present disclosure is useful as an information display apparatus, a method for displaying information, and the like which can make a user recognize at a glance a relation between a graphic object and an object in a real environment which is targeted by information shown by the graphic object. Specifically, the present disclosure can be applied to a car navigation system, a PND (Personal Navigation Device), a smartphone, a tablet terminal, a wearable terminal, and the like.

1. An information display apparatus comprising:
a display unit on which a graphic object is displayed to be superimposed on a real environment;
a first detector which detects a current position of the information display apparatus and a direction in which the real environment is located when viewed from the information display apparatus at the current position;
an acquisition unit which acquires area information related to an area including the detected current position;
a generation unit which generates (i) a first graphic object for providing guidance to a user about areas around the detected current position, based on the area information, the detected current position, and the detected direction and which generates (ii) for each of a plurality of first areas into which an area of the first graphic object is divided, distance information indicating a first distance which is determined based on the area information and which is a distance to be used for the first graphic object and is a distance, in the direction, from the information display apparatus;
a second detector which detects, for each of a plurality of second areas in the real environment corresponding to the plurality of first areas, a second distance which is a distance, in the direction, from the information display apparatus to the real environment;
a comparator which compares, for each of the plurality of first areas, the first distance of the first area indicated by the distance information with the second distance detected for a second area corresponding to the first area; and
a display controller which (i) generates, based on a result of comparison by the comparator, a second graphic object from the first graphic object by removing a first area, which is one of the plurality of first areas, the first distance of which is more distant, in the direction, from the information display apparatus than the second distance is and which (ii) displays the second graphic object on the display unit.

2. The information display apparatus according to claim 1, wherein the generation unit generates the first graphic object such that two areas overlap at least partly each other,
one of the two areas is an area in which the first graphic object is displayed on the display unit,
the other of the two areas is an area in which an object in the real environment is visible on the display unit, and
the object in the real environment is a target which the first graphic object is showing.

3. The information display apparatus according to claim 1, further comprising an eye-gaze detector which detects an eye-gaze direction of the user,
wherein the second detector detects a distance, in the direction, from the information display apparatus to an object only in the real environment ahead in the eye-gaze direction as the second distance.

4. The information display apparatus according to claim 3, wherein the display controller does not display the second graphic object or increases a transmittance of display of the second graphic object when the eye-gaze direction is directed to an area other than an area on the display unit in which the second graphic object is to be displayed.

5. The information display apparatus according to claim 1, further comprising:
an imager which takes an image of the real environment; and
a third detector which detects from an image taken by the imager a moving object area in which an object moving in the real environment is imaged,
wherein the display controller further generates a third graphic object from the second graphic object by removing an area which is part of the second graphic object and corresponds to the detected moving object area, and
the display controller displays the third graphic object on the display unit.

6. The information display apparatus according to claim 1, further comprising a reception unit which receives, from the user, an input indicating a destination,
wherein the acquisition unit acquires map information as the area information, and
the generation unit generates as the first graphic object a graphic object for showing a route from the current position to the destination, based on the map information, the detected current position and the direction, and the destination indicated by the input.

7. The information display apparatus according to claim 1, wherein (i) the display unit includes a projection unit which projects an image, and an image forming part which is formed of a transparent member in a panel shape and on which the image projected by the projection unit is formed, and
(ii) on the display unit, the second graphic object is displayed as an image which is superimposed on the real environment seen through the image forming part.

8. The information display apparatus according to claim 1, wherein (i) the second detector is a stereo camera having two imagers which take images of the real environment in the direction, and
(ii) the second detector detects the second distance, based on a disparity between a first image taken by one of the imagers and a second image taken by the other of the imagers.

9. A method for displaying information in an information display apparatus which is equipped with a display unit on a display surface of which a graphic object is displayed to be superimposed on a real environment, the method comprising:
detecting a current position of the information display apparatus and a direction in which the real environment is located when viewed from the information display apparatus at the current position;
acquiring area information related to an area including the detected current position;
generating (i) a first graphic object for providing guidance to the user about areas around the current position, based on the acquired area information, the detected current position, and the detected direction and (ii) for each of a plurality of first areas into which an area of the first graphic object is divided, distance information indicating a first distance which is determined based on the area information and which is a distance to be used for the first graphic object and is a distance, in the direction, from the display surface;
detecting, for each of a plurality of second areas in the real environment corresponding to the plurality of first areas, a second distance which is a distance, in the direction, from the display surface to the real environment;
comparing, for each of the plurality of first areas, the first distance of the first area indicated by the distance information with the second distance detected in a second area corresponding to the first area;
(i) generating, based on a result of comparison, a second graphic object from the first graphic object by removing a first area, which is one of the plurality of first areas, the first distance of which is more distant, in the direction, from the display surface than the second distance is and (ii) displaying the second graphic object on the display unit.
